(19) United States
(12) Patent Application Publication
(10) Pub. No.: US 2026/0369495 A1
(43) Pub. Date: Nov. 19, 2026

(54) INTERRUPTION DEVICE

(71) Applicant: Panasonic Intellectual Property Management Co., Ltd., Osaka (JP)

(72) Inventors: MASATO NAKAMURA, Hyogo (JP); SHUN ITO, Hyogo (JP); YOICHIRO MORIYAMA, Osaka (JP); SHINYA KIMOTO, Osaka (JP)

(21) Appl. No.: 19/148,211

(22) PCT Filed: Dec. 25, 2023
(86) PCT No.: PCT/JP2023/046326

§ 371 Date: Jul. 15, 2025

(30) Foreign Application Priority Data
Feb. 3, 2023 (JP) 2023-015191

(51) Int. Cl. H01H 39/00; H01H 9/34

(52) U.S. Cl. CPC H01H 39/006; H01H 9/34

(57) ABSTRACT

This breaker device (1) includes: an igniter (10) configured to generate gas; a pusher (60) located at a level below the igniter (10); a conductor (50) including a separating portion (51) located below the pusher (60) and a holding portion (52) connected to the separating portion (51); a lower casing (30) located at a level below the separating portion (51) and made from metal; an insulating member (110) located inside the lower casing (30) and positioned at a level below the separating portion (51); and a resin member (40) located at least partially inside the lower casing (30) and configured to hold the holding portion (52). The pusher (60) is configured to cut off the separating portion (51) from the conductor (50) by receiving the pressure of the gas generated by the igniter (10). The resin member (40) and the insulating member (110) cover the inner surface of the lower casing (30). An end (113) of the insulating member (110) and an end (43a) of the resin member (40) overlap each other. A lower end (43b) of the end (43a) of the resin member (40) is located at a level below an upper end (113a) of the end (113) of the insulating member (110).

### TECHNICAL FIELD

The present disclosure relates to breaker devices.

### BACKGROUND ART

There are conventionally known breaker devices that, when in use, are connected to an electrical circuit. Patent Literature (PTL) 1 discloses a breaker device including a housing (casing) inside which a reinforcing frame is disposed.

### CITATION LIST

### Patent Literature

PTL 1: International Publication No. 2018/003594.

### SUMMARY OF INVENTION

### Technical Problem

In electrical circuits on electric vehicles and the like, the importance of a breaker device capable of more reliably interrupting the electrical circuits has been increasing from the perspective of preventing significant damage.

A breaker device according to one aspect of the present disclosure includes: an igniter configured to generate gas; a pusher located at a level below the igniter; a conductor including a separating portion located below the pusher and a holding portion connected to the separating portion; a cover member located at a level below the separating portion and made from metal; an insulating member located inside the cover member and positioned at a level below the separating portion; and a resin member located at least partially inside the cover member and configured to hold the holding portion. The pusher is configured to cut off the separating portion from the conductor by receiving pressure of the gas generated by the igniter. The resin member and the insulating member cover an inner surface of the cover member. An end of the insulating member and an end of the resin member overlap each other. A lower end of the end of the resin member is located at a level below an upper end of the end of the insulating member.

According to one aspect of the present disclosure, it is possible to realize a breaker device capable of exhibiting improved insulation performance.

### BRIEF DESCRIPTION OF DRAWINGS

FIG. 1A is a front view illustrating a breaker device according to Embodiment 1.

FIG. 1B is a perspective view illustrating a breaker device according to Embodiment 1.

FIG. 2A is a cross-sectional view illustrating the configuration of a breaker device according to Embodiment 1 before an interrupting operation.

FIG. 2B is a cross-sectional view illustrating the configuration of a breaker device according to Embodiment 1 after an interrupting operation.

FIG. 3A is a perspective view of an insulating member according to Embodiment 1 viewed from above.

FIG. 3B is a front view illustrating an insulating member according to Embodiment 1.

FIG. 3C is a perspective view of an insulating member according to Embodiment 1 viewed from below.

FIG. 4A is a perspective view of a lower casing according to Embodiment 1 viewed from above.

FIG. 4B is a front view illustrating a lower casing according to Embodiment 1.

FIG. 4C is a perspective view of a lower casing according to Embodiment 1 viewed from below.

FIG. 5 is a cross-sectional view illustrating the configuration of a breaker device according to Embodiment 2 before an interrupting operation.

FIG. 6A is a perspective view of an insulating member according to Embodiment 2 viewed from above.

FIG. 6B is a front view illustrating an insulating member according to Embodiment 2.

FIG. 6C is a perspective view of an insulating member according to Embodiment 2 viewed from below.

FIG. 7 is a cross-sectional view illustrating the configuration of a breaker device according to a variation of Embodiment 2 before an interrupting operation.

FIG. 8 is a front view illustrating an insulating member according to a variation of Embodiment 2.

FIG. 9 is a cross-sectional view illustrating the configuration of a breaker device according to Embodiment 3 before an interrupting operation.

FIG. 10A is a perspective view of an insulating member according to Embodiment 3 viewed from above.

FIG. 10B is an exploded perspective view of an insulating member according to Embodiment 3 viewed from above.

FIG. 11 is a flowchart illustrating a manufacturing process of a breaker device according to an exemplary embodiment or the like.

### DESCRIPTION OF EMBODIMENTS

A breaker device according to one aspect of the present disclosure includes: an igniter configured to generate gas; a pusher located at a level below the igniter; a conductor including a separating portion located below the pusher and a holding portion connected to the separating portion; a cover member located at a level below the separating portion and made from metal; an insulating member located inside the cover member and positioned at a level below the separating portion; and a resin member located at least partially inside the cover member and configured to hold the holding portion. The pusher is configured to cut off the separating portion from the conductor by receiving pressure of the gas generated by the igniter. The resin member and the insulating member cover an inner surface of the cover member. An end of the insulating member and an end of the resin member overlap each other. A lower end of the end of the resin member is located at a level below an upper end of the end of the insulating member.

Thus, the end of the insulating member and the end of the resin member are arranged so as to overlap each other and therefore, an electric arc or electrically conductive gas generated by the electric arc (hereinafter referred to as conductive gas or the like) is cooled when flowing in between the end of the insulating member and the end of the resin member, allowing for a reduction in the electrical conductivity of said conductive gas or the like. Specifically, the electric current blocked as a result of the separating portion being cut off from the pusher is kept from flowing again through the cover member made from metal when the conductive gas or the like contacts the cover member. Thus, it is possible to improve the insulation performance of the breaker device from the perspective of keeping the electric current from flowing again.

Furthermore, for example, the end of the insulating member may be located between the end of the resin member and the cover member.

Thus, when the end of the insulating member is located between the end of the resin member and the cover member, the creepage distance of the electric arc between the cut surface of the separating portion and the cover member can be increased, making it easier to extinguish the electric arc. Furthermore, with the high-temperature conductive gas generated during the interrupting operation, the resin member moves (or deforms) the insulating member toward the outside of the breaker device (radially outward), meaning that the spacing between the insulating member and the resin member can be reduced, allowing for an effective reduction in the electrical conductivity of the conductive gas or the like. As a result, the breaker device can more reliably prevent the electric current from flowing again.

Furthermore, for example, the end of the resin member may be located between the end of the insulating member and the cover member.

Thus, when the end of the resin member is located between the end of the insulating member and the cover member, the creepage distance of the electric arc between the cut surface of the separating portion and the cover member can be increased, making it easier to extinguish the electric arc, meaning that it is possible to more reliably prevent the electric current from flowing again.

Furthermore, for example, the cover member may include a projecting portion located below the insulating member, and the projecting portion may protrude upward and may be pressed by the pusher.

Thus, the projecting portion of the cover member is located below the insulating member (in other words, the insulating member is located between the separating portion and the cover member) and therefore, a path in which the electric arc is generated can be extended; as a result, it is possible to more reliably prevent the electric current from flowing again.

Furthermore, for example, a gap may be provided between the cover member and the insulating member, and the gap may be located below the insulating member.

Thus, the insulating member can move downward a distance corresponding to the gap when pressed by the pusher and therefore, the insulating member can be protected from being damaged by the pressure from the pusher. Thus, it is possible to improve the insulation performance of the breaker device from the perspective of protecting the insulating member from damage.

Furthermore, for example, a gap may be provided between the cover member and the insulating member, the insulating member may include: a first section covering a top of the projecting portion of the cover member; and a second section located at a level below the first section, the second section may cover an inner surface of a bottom portion of the cover member, and the gap may be located between the bottom portion of the cover member and a lower surface of the second section.

Thus, the insulating member can move downward a distance corresponding to the gap when the projecting portion is pressed by the pusher and therefore, the insulating member can be protected from being damaged by the pressure from the pusher. Thus, it is possible to improve the insulation performance of the breaker device from the perspective of protecting the insulating member from damage.

Furthermore, for example, the insulating member may include: a first member covering a top of the projecting portion of the cover member; and a second member disposed to partially overlap the first member, the second member may cover an inner surface of a bottom portion of the cover member, and the first member and the second member may be separate members.

Thus, the insulating member is formed of two members and as a result, it is possible to disperse stress that is applied to the insulating member when the projecting portion is pressed by the pusher, meaning that the insulating member can be protected from damage. Thus, it is possible to improve the insulation performance of the breaker device from the perspective of protecting the insulating member from damage.

Furthermore, for example, the resin member may include: an embedding portion in which the holding portion is embedded; a first cylindrical portion in which the pusher is disposed; and a second cylindrical portion located at a level below the first cylindrical portion and having a diameter greater than a diameter of the first cylindrical portion, and an inner diameter of the second cylindrical portion may be less than an inner diameter of the insulating member.

Thus, the insulating member covers the inner surface of the cover member and therefore, it is possible to keep the electric current from flowing again while maintaining the size of the space in which the electric arc is extended (while keeping the breaker device from increasing in size).

Note that each of the exemplary embodiments, etc., described below shows a general or specific example. The numerical values, shapes, structural elements, the arrangement and connection of the structural elements, steps (manufacturing steps), the processing order of the steps (manufacturing steps), etc., shown in the following exemplary embodiments, etc., are mere examples, and are not intended to limit the present disclosure. Among the structural elements in the following exemplary embodiments, structural elements not recited in any one of the independent claims are described as optional structural elements.

Note that the figures are schematic diagrams and are not necessarily precise illustrations. Therefore, for example, scale reduction and the like in the figures are not necessarily the same. Furthermore, in the figures, substantially identical elements are assigned the same reference signs, and overlapping description will be omitted or simplified.

In the present specification and the drawings, the X-axis, the Y-axis, and the Z-axis represent three axes of the right-handed three-dimensional Cartesian coordinate system. In each of the exemplary embodiments, etc., the Z-axis direction is a direction of movement of the pusher, the Y-axis direction is a direction in which the conductor extends, and the X-axis direction is the width direction of the conductor. In the present specification, the phrase “as viewed from the front/in a front view” indicates viewing from the positive side of the X-axis to the negative side of the X-axis, the phrase “as viewed from above” indicates viewing from the positive side of the Z-axis to the negative side of the Z-axis, the phrase “in a cross-sectional view” indicates viewing a cut surface of the breaker device that has been cut through by a plane extending through the Z-axis and parallel to the Z-axis, and the term “lateral/side” indicates a direction perpendicular to the Z-axis direction. Furthermore, in the present specification, the Z-axis direction is also referred to as the up-down or vertical direction. Note that the up-down or vertical direction of the breaker device in the present specification merely indicates relative positioning of elements included in the breaker device for the sake of description of each of the exemplary embodiments, etc. For example, in the present specification, the terms “up/upward/above/top” and “down/downward/below/bottom” do not indicate an upward direction (vertically upward) and a downward direction (vertically downward) in a sense of absolute space, but are used as terms defined by relative positioning on the basis of the direction of movement of the pusher. The posture of the breaker device when installed is not limited by the directions illustrated in the drawings.

Furthermore, in the present specification, terms indicating the relationship between elements such as being equal and being perpendicular, terms indicating the shapes of elements such as a circle, numerical values, and numerical ranges are not expressions referring to only exact meanings, but are expressions referring to substantially equivalent ranges including, for example, approximately a few percent (or approximately 10%) differences.

Furthermore, in the present specification, ordinal numbers such as “first” and “second” do not indicate the number of structural elements or the sequence of structural elements, but are used for the purpose of avoiding confusion and distinguishing between structural elements of the same kind, unless otherwise noted.

### Embodiment 1

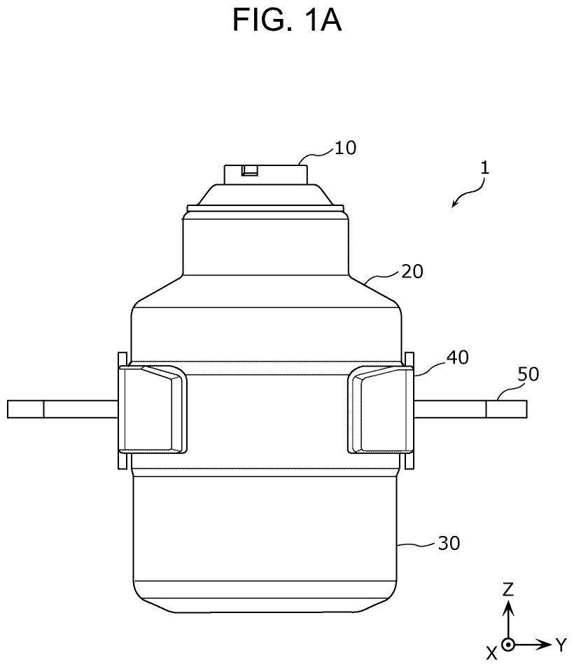

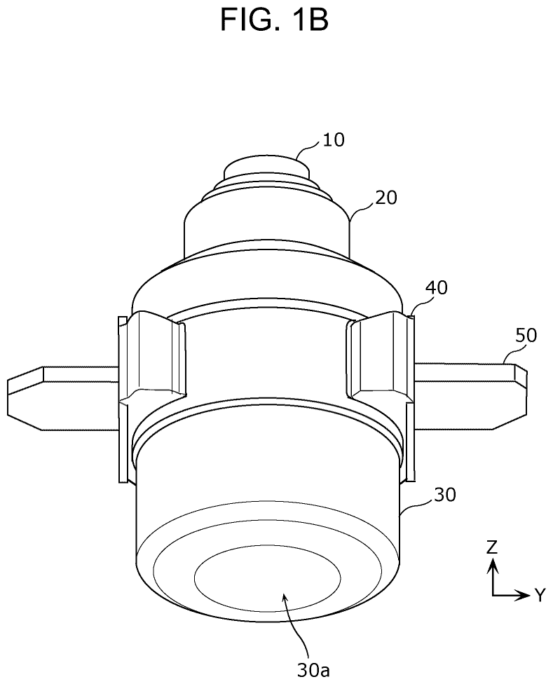

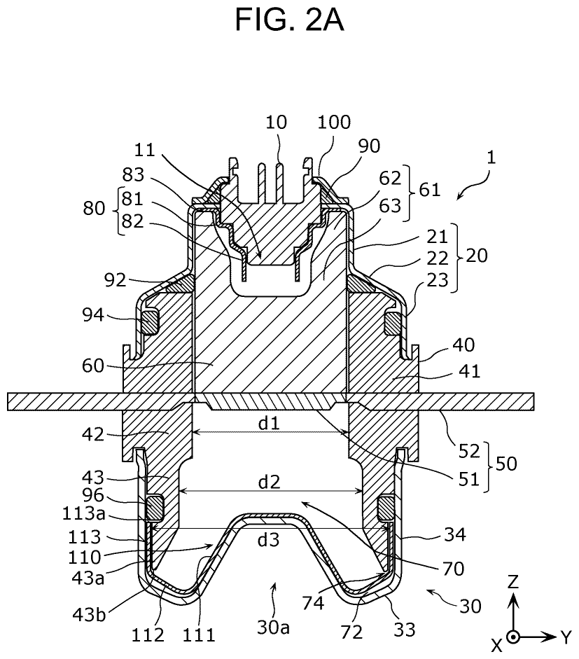

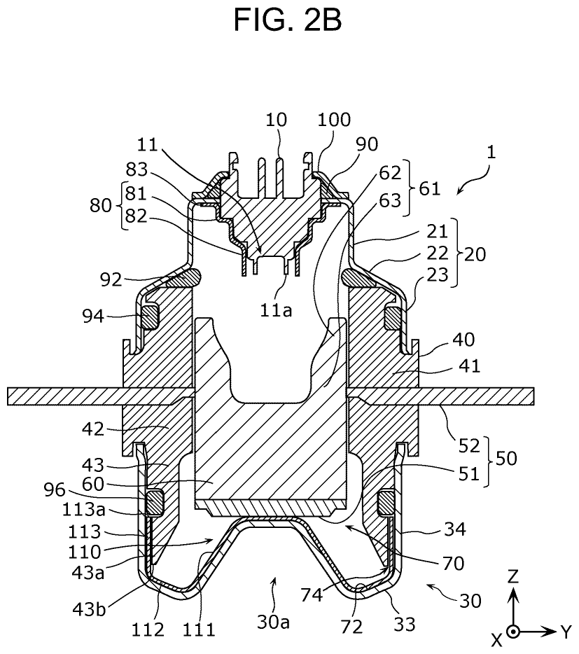

Hereinafter, the configuration of the breaker device according to the present exemplary embodiment will be described with reference to FIG. 1A to FIG. 4C. FIG. 1A is a front view illustrating breaker device 1 according to the present exemplary embodiment. FIG. 1B is a perspective view illustrating breaker device 1 according to the present exemplary embodiment. FIG. 2A is a cross-sectional view illustrating the configuration of breaker device 1 according to the present exemplary embodiment before an interrupting operation. FIG. 2B is a cross-sectional view illustrating the configuration of breaker device 1 according to the present exemplary embodiment after the interrupting operation. FIG. 1B is a diagram of breaker device 1 illustrated in FIG. 1A that has been rotated about the Y-axis as a rotation axis to obtain a perspective view of breaker device 1 viewed from below.

Note that in a perspective view, when there are axes oriented in the same direction on the drawing where the three axes of a three-dimensional Cartesian coordinate system are indicated, only one of the axes is illustrated. For example, in FIG. 1B, the X-axis and the Z-axis are oriented in the same direction on the drawing and therefore, only the Z-axis is illustrated.

As illustrated in FIG. 1A to FIG. 2B, breaker device 1 includes igniter 10, upper casing 20, lower casing 30, resin member 40, conductor 50, pusher 60, protective portion 80, elastic members 90, 92, 94, 96, and insulating member 110. Breaker device 1 is a device that is mounted on an object including an electrical circuit and operates to interrupt the electrical circuit when an anomaly occurs in the electrical circuit, a system, or the like in the object, to thereby prevent damage caused by the anomaly from becoming severe. For example, breaker device 1 is mounted on a vehicle, which is an example of the object, and is connected between a motor and a battery (for example, a lithium-ion battery) for driving the motor to interrupt the electrical connection between the motor and the battery for driving the motor in the event of emergency situations such as malfunctions and accidents. Note that the object may be other than a vehicle; examples of the object include, but are not particularly limited to, a home appliance and a photovoltaic system.

Igniter 10 holds gunpowder inside, includes lid portion 11 between the gunpowder and pusher 60, is disposed inside recessed portion 61, and generates gas. For example, igniter 10 is an electric igniter including: a gunpowder portion including an ignition charge; and a conducting pin for passing an electric current through the gunpowder portion. During operation, an operating current for igniting the ignition charge is supplied from an external power supply to the conducting pin, thus the ignition charge is ignited and burnt, and gas (combustion gas) is generated. Note that when recessed portion 61 is formed, breaker device 1 can be reduced in size.

Igniter 10 is fixed to small-diameter portion 21 located at the top of upper casing 20.

Upper casing 20 and lower casing 30, which are members constituting the outer full of breaker device 1, house igniter 10, a portion of each of resin member 40 and conductor 50, pusher 60, protective portion 80, elastic members 92, 94, 96, and insulating member 110. Space 70 extending in the up-down direction is formed inside upper casing 20 and lower casing 30. Space 70 is a space formed in the shape of a circular cylinder so that pusher 60 can move therein. Pusher 60 is housed in an area of space 70 that is located at the upper end (on the positive side of the Z-axis) in the up-down direction (the Z-axis direction).

Each of upper casing 20 and lower casing 30 is formed from a metal such as stainless steel (SUS), but may be formed from other metals such as aluminum. For example, each of upper casing 20 and lower casing 30 is made from metal. Note that it is sufficient that at least lower casing 30 be made from metal and upper casing 20 may be made from resin, for example.

The outer shape of each of upper casing 20 and lower casing 30 is, but not limited to, a circular cylinder. Upper casing 20 and lower casing 30 are directly connected and fixed by welding or the like, for example. Lower casing 30 is an example of the cover member. Each of upper casing 20 and lower casing 30 is an example of the casing.

Upper casing 20, which is a cylinder member having the shape of a circular cylinder with a step, for example, is hollow inside. Upper casing 20 includes: small-diameter portion 21 located in an upper area; large-diameter portion 23 located in a lower area; and connecting portion 22 that connects these small-diameter and large-diameter portions. Small-diameter portion 21, connecting portion 22, and large-diameter portion 23 are integrally formed. Small-diameter portion 21 and large-diameter portion 23 are coaxially disposed, and large-diameter portion 23 is larger in diameter than small-diameter portion 21.

Lower casing 30, which is a member located at a level below separating portion 51 and having the shape of a hollow cylinder with a closed bottom, includes projecting portion 30a that protrudes upward. Specifically, lower casing 30 includes projecting portion 30a, bottom portion 33, and side wall portion 34. Projecting portion 30a, bottom portion 33, and side wall portion 34 are integrally formed.

Note that in the present specification, being integrally formed means at least one of the following: that components are formed of the same material; that components are formed at the same time; and that components are the same object (a single object), for example.

Projecting portion 30a is located below separating portion 51 and configured so as to protrude upward in space 70. Projecting portion 30a is connected to one end of bottom portion 33 and protrudes upward (on the positive side of the Z-axis) from bottom portion 33 in space 70. Projecting portion 30a is configured so as to deform downward by being pressed by insulating member 110 in contact with pusher 60 that has moved downward by the gas generated by igniter 10. This means that projecting portion 30a has the function of absorbing the impact (stress) from pusher 60 by deforming when pressed by pusher 60. Projecting portion 30a is located below insulating member 110.

Projecting portion 30a, which forms the recessed portion of lower casing 30 when breaker device 1 is viewed from the negative side of the Z-axis to the positive side of the Z-axis, is exposed as viewed from the outside of breaker device 1. In the present exemplary embodiment, projecting portion 30a is tapered upward in space 70, but the shape of projecting portion 30a is not limited to this tapered shape.

Bottom portion 33 connects projecting portion 30a and side wall portion 34. In other words, projecting portion 30a and side wall portion 34 are connected via bottom portion 33. Bottom portion 33 has an outer surface and an inner surface each inclined upward from projecting portion 30a to side wall portion 34.

Side wall portion 34 is connected to the other end of bottom portion 33 and is formed so as to extend upward from bottom portion 33. Side wall portion 34 has the shape of a cylinder; in the present exemplary embodiment, side wall portion 34 has the shape of a circular cylinder. Side wall portion 34 is disposed coaxially with small-diameter portion 21 and large-diameter portion 23. The diameter of side wall portion 34 is equal to the diameter of large-diameter portion 23, for example.

Projecting portion 30a, bottom portion 33, and side wall portion 34 have the same thickness in the present exemplary embodiment, but may have different thicknesses, for example.

Resin member 40 is a member that is located at least partially inside lower casing 30 and covers a portion (specifically, holding portion 52) of conductor 50. It can also be said that resin member 40 holds holding portion 52. Resin member 40 is a part of structural elements that form space 70. Resin member 40 includes embedding portion 41, first cylindrical portion 42, and second cylindrical portion 43.

Embedding portion 41 is a part of resin member 40 in which conductor 50 (specifically, holding portion 52) is embedded. Embedding portion 41 is partially exposed from the casing, for example. Embedding portion 41 has a through-hole in which conductor 50 (specifically, holding portion 52) is disposed. Embedding portion 41 constitutes a part of first cylindrical portion 42.

First cylindrical portion 42, which is a portion of resin member 40 that is disposed in the casing, is where pusher 60 is disposed during a non-interrupting operation (while no gas is generated by igniter 10). This means that first cylindrical portion 42 is located between the casing and pusher 60. The inner diameter of first cylindrical portion 42 is less than the inner diameter of second cylindrical portion 43.

Second cylindrical portion 43, which is a portion of resin member 40 that is disposed in the casing, is a portion located at a level below first cylindrical portion 42. The diameter of second cylindrical portion 43 is greater than the diameter of first cylindrical portion 42. For example, inner diameter d2 of second cylindrical portion 43 (refer to FIG. 2A) is greater than inner diameter d1 of first cylindrical portion 42 (refer to FIG. 2A). Thus, the volume of the lower area of space 70 can be made large. This makes it possible to reduce an increase in the pressure inside the casing that is caused by the gas generated by igniter 10 and the following downward movement of pusher 60, meaning that the deformation of breaker device 1 can be minimized. Note that inner diameter d2 of second cylindrical portion 43 is less than inner diameter d3 of insulating member 110. This means that the inner diameters of first cylindrical portion 42, second cylindrical portion 43, insulating member 110, and lower casing 30 increase in ascending order.

Second cylindrical portion 43 includes end 43a in the lower area. End 43a is a portion disposed inside lower casing 30 and located, for example, at a level below elastic member 96. End 43a is formed tapered with an inner diameter increasing downward, for example, but the shape of end 43a is not limited to the tapered shape.

In this manner, pusher 60 moves in space 70 formed by first cylindrical portion 42 and second cylindrical portion 43. Note that first cylindrical portion 42 and second cylindrical portion 43 are not limited to having different inner diameters and may have the same inner diameter.

Conductor 50 is an electrically conductive metal body that is partially located in upper casing 20 and lower casing 30. When breaker device 1 is mounted on a predetermined electrical circuit, conductor 50 forms a part of said electrical circuit and is also referred to as a busbar. Conductor 50 is a flat member held on resin member 40 and disposed so as to cross the interior of each of upper casing 20 and lower casing 30. Conductor 50 includes separating portion 51 and holding portion 52.

Separating portion 51, which is a portion of conductor 50 to be cut off by pusher 60 under the pressure of the gas generated by igniter 10, is located below pusher 60 at the initial position.

Holding portion 52 is a portion of conductor 50 that is connected to separating portion 51 and held by resin member 40. Holding portion 52 is a portion that does not overlap pusher 60 as viewed from above; for example, holding portion 52 is a portion that overlaps resin member 40 and is a portion located outside of the casing as viewed from above. Holding portion 52 remains held by resin member 40 even after separating portion 51 is cut off.

Conductor 50 can be formed from a metal such as copper (Cu), for example. Note that conductor 50 may be formed from a metal other than copper or may be formed from an alloy of copper and another metal. For example, conductor 50 may contain manganese (Mn), nickel (Ni), platinum (Pt), or the like.

Pusher 60 is positioned at a level below igniter 10 and disposed so as to be able to move downward and, for example, when an anomaly occurs in the system, moves downward to cut conductor 50 and interrupt the flow of an electric current through the electrical circuit as an emergency measure. Thus, pusher 60 is configured so as to cut off separating portion 51 from conductor 50 by receiving the pressure of the gas generated by igniter 10. In this manner, pusher 60 is disposed at a first position between separating portion 51 and igniter 10 (refer to FIG. 2A), and cuts off separating portion 51 and moves from the first position to a second position (refer to FIG. 2B) located below the first position. The second position is, for example, the position of pusher 60 that has moved downward together with separating portion 51 until separating portion 51 comes into contact with projecting portion 30a.

Pusher 60 is formed from an insulating member such as a synthetic resin, for example. In the present exemplary embodiment, pusher 60 is formed from nylon. Pusher 60 has the shape of a circular column with an outer diameter corresponding to the inner diameter of small-diameter portion 21 of upper casing 20. Pusher 60 includes recessed portion 61, and igniter 10 is disposed inside recessed portion 61. Note that the shape of pusher 60 is not limited to said shape and can be changed, as appropriate, according to the shape, etc., of each of upper casing 20 and lower casing 30. Recessed portion 61 is an upper portion of pusher 60 where a recessed portion directed downward is provided.

Recessed portion 61 includes, as viewed from above: first section 62 having a diameter (for example, an inner diameter) greater than the diameter of first cylindrical portion 81 of protective portion 80; and second section 63 located at a level below first section 62 and having a diameter (for example, an inner diameter) greater than the diameter of second cylindrical portion 82. As viewed from above, the diameter of first section 62 is greater than the diameter of second section 63. For example, in a cross-sectional view, the inner wall of first section 62 is tapered with a diameter reduced toward second section 63, but may be, for example, in the shape of a staircase with a diameter reduced stepwise.

Protective portion 80 is a structural element for protecting pusher 60 from being damaged by opening portion 11a of lid portion 11 of igniter 10 (refer to FIG. 2B) when igniter 10 generates gas. Specifically, protective portion 80 is a member serving as a barrier to opening portion 11a that may open wide, to reduce the occurrence of opening portion 11a opened as a result of the gas generation by igniter 10 coming into contact with pusher 60 and damaging recessed portion 61 of pusher 60.

Protective portion 80 is provided on the casing (for example, upper casing 20) or igniter 10 and includes a part located inside recessed portion 61. In the present exemplary embodiment, protective portion 80 is provided on the casing (specifically, small-diameter portion 21). Protective portion 80 is fixed to small-diameter portion 21 by welding, for example, but the fixing method is not limited to welding.

As illustrated in FIG. 2A and FIG. 2B, protective portion 80 includes first cylindrical portion 81 and second cylindrical portion 82. First cylindrical portion 81 and second cylindrical portion 82 are integrally formed.

First cylindrical portion 81, which is a portion in the shape of a cylinder surrounding the lateral side of igniter 10, has a shape corresponding to igniter 10. In the present exemplary embodiment, first cylindrical portion 81 is formed in the shape of a staircase (for example, in the form of a two-step staircase) with a diameter (for example, an inner diameter) reduced stepwise downward in a cross-sectional view. Note that the shape of first cylindrical portion 81 is not limited to this shape; for example, first cylindrical portion 81 may be tapered with a diameter reduced downward or may have another shape.

First cylindrical portion 81 may be at least partially in contact with igniter 10. Second cylindrical portion 82 is disposed at the lower end of first cylindrical portion 81.

First cylindrical portion 81 includes flange portion 83 at the top. Flange portion 83, which is a ring-shaped portion (for example, a plate-shaped member) formed so as to protrude outward from the upper end of first cylindrical portion 81 as viewed from above, is fixed to small-diameter portion 21 by welding or the like. At least a part of flange portion 83 is disposed between first section 62 and small-diameter portion 21, for example. Thus, first cylindrical portion 81 includes a part connected to the casing and is fixed to the casing.

Second cylindrical portion 82 is a ring-shaped part located at a level below first cylindrical portion 81 and having a diameter (for example, an inner diameter) less than the diameter of first cylindrical portion 81. Second cylindrical portion 82 is a part that protrudes straight from the lower end of first cylindrical portion 81 on the negative side of the Z-axis and when the gas is generated, comes into contact with lid portion 11. The lower end (the end located on the negative side of the Z-axis, that is, the lowest end, for example) of second cylindrical portion 82 is located at a level below (on the negative side of the Z-axis from) the lower end (the end located on the negative side of the Z-axis, that is, the lowest end, for example) of lid portion 11 in the state where no gas is generated.

Protective portion 80 is formed from a metal such as stainless steel (SUS), for example, but may be formed from other metals such as aluminum or may be formed from a resin (for example, a resin different from that of pusher 60).

As illustrated in FIG. 2A and FIG. 2B, elastic members 90, 92, 94, 96, which are members with elasticity such as rubber, are O-rings each formed in the shape of a ring. Each of elastic members 90, 92, 94, 96, is disposed in the state of being pressed (a deformed state).

Elastic member 90 is disposed in the space formed between small-diameter portion 21, igniter 10, and fixing member 100 for fixing igniter 10 disposed inside recessed portion 61. Elastic member 90 is in contact with each of fixing member 100, igniter 10, and small-diameter portion 21 and, for example, is pressed by each of fixing member 100, igniter 10, and small-diameter portion 21.

Elastic member 92 is positioned between the casing and pusher 60 and provided so as to be pressed against the casing and press the outer side surface of pusher 60. Elastic member 92 is disposed so as to extend along the outer side surface of pusher 60. In the present exemplary embodiment, elastic member 92 is disposed in the space formed between the casing (for example, connecting portion 22), pusher 60, and resin member 40 in order to keep the internal space of recessed portion 61 and the space outside of said internal space (for example, the space between pusher 60 and resin member 40) from being spatially connected. Elastic member 92 reduces the leakage of the gas generated by igniter 10 into the space outside of the internal space of recessed portion 61. With this, it is possible to minimize a reduction in the pressure of the gas inside recessed portion 61 that is due to the gas generated by igniter 10 escaping from the internal space of recessed portion 61.

In the present exemplary embodiment, elastic member 92 is in contact (for example, surface contact) with the casing, pusher 60, and resin member 40 and, for example, is pressed by each of the casing, pusher 60, and resin member 40.

As illustrated in FIG. 2A, the shape of a cross section of elastic member 92 when pressed is triangular, but the cross-section of elastic member 92 is not limited to this shape. The shape of the cross section of elastic member 92 when not pressed is not particularly limited as long as the internal space of recessed portion 61 and conductor 50 can be spatially separated after pressing; said shape may be a circle, may be a polygon (for example, a square), or may be an ellipse.

Note that in the present specification, the term “pressing” includes, in addition to a situation in which one member presses the other member, a situation in which with a repulsive force generated as a result of elastic deformation of said other member, said other member presses said one member or another member.

Elastic member 94 is disposed in the space formed above conductor 50, between the casing (for example, large-diameter portion 23) and a circumferential recessed portion formed on resin member 40, in order to keep the exterior space and the space located above conductor 50 from being spatially connected. In the present exemplary embodiment, elastic member 94 is located between and in contact with resin member 40 and large-diameter portion 23 and, for example, is pressed by each of resin member 40 and large-diameter portion 23.

Elastic member 96 is disposed in the space formed below conductor 50, between lower casing 30 (for example, side wall portion 34) and a circumferential recessed portion formed on resin member 40, in order to keep the exterior space and the space located below conductor 50 from being spatially connected. In the present exemplary embodiment, elastic member 96 is located between and in contact with resin member 40 and side wall portion 34 and, for example, is pressed by each of resin member 40 and side wall portion 34.

Note that elastic members 94, 96 are not limited to being disposed in the circumferential recesses without spacing; spacing may be formed in at least one of the up and down directions.

Insulating member 110 is a member having insulating properties, located inside lower casing 30, and positioned at a level below separating portion 51. The shape of insulating member 110 preferably follows the shape of lower casing 30. For example, when lower casing 30 includes an inclined portion (for example, bottom portion 33), it is preferable that insulating member 110 also include an inclined portion (for example, a portion of second section 112 that is inclined). In the present exemplary embodiment, insulating member 110 is provided along the inner surface of lower casing 30 and formed as a layer having a predetermined thickness. The thickness of insulating member 110 may be less than the thickness of lower casing 30, for example.

Insulating member 110 includes first section 111 and second section 112.

First section 111, which is a portion of insulating member 110 that has a shape following projecting portion 30a, covers the inner surface of projecting portion 30a. First section 111 is provided so as to cover the top of projecting portion 30a, for example. In the present exemplary embodiment, first section 111 is provided so as to contact the inner surface of projecting portion 30a.

Second section 112 is located at a level below first section 111 and covers the inner surface of bottom portion 33. In the present exemplary embodiment, second section 112 is provided without contact with bottom portion 33 before an interrupting operation. As a result, spacing 72 (refer to FIG. 2A), which is located below insulating member 110, is provided between insulating member 110 and lower casing 30 (for example, bottom portion 33) (the lower surface of second section 112 and bottom portion 33). Spacing 72 is an example of the gap.

When spacing 72 is provided, insulating member 110 can move (deform) into spacing 72 when projecting portion 30a deforms, meaning that insulating member 110 can be protected from being damaged by stress. Second section 112 further covers the inner surface of a part of side wall portion 34. Assuming that a portion of second section 112 that is provided along the inner surface of side wall portion 34 is end 113, inner diameter d3 of insulating member 110 is the distance in the Y-axis direction between radially facing ends 113 in the example in FIG. 2A.

Note that the size of spacing 72 may be determined according to the expected size of deforming projecting portion 30a by, for example, setting the height of projecting portion 30a (the length thereof in the Z-axis direction) greater than the height of the projection of insulating member 110.

First section 111 and second section 112 are integrally formed. Insulating member 110 is formed from a resin having insulating properties (for example, a synthetic resin), for example. For example, insulating member 110 is formed by shaping the resin.

Note that insulating member 110 may be realized by applying an insulating material to the inner surface of lower casing 30. For example, insulating member 110 may be formed by coating the inner surface of lower casing 30 with an insulating material such that the inner surface of lower casing 30 is covered. In this case, insulating member 110 and lower casing 30 are integrally provided.

As illustrated in FIG. 2A and FIG. 2B, resin member 40 and insulating member 110 cover the inner surface of lower casing 30 before and after the interrupting operation. Resin member 40 and insulating member 110 may cover the inner surface of lower casing 30 so that the inner surface of lower casing 30 is not exposed, for example. Resin member 40 and insulating member 110 partially overlap each other as viewed in the radial direction. Specifically, end 113 of insulating member 110 and end 43a of resin member 40 overlap each other in the radial direction. More specifically, lower end 43b of end 43a of resin member 40 is located at a level below upper end 113a of end 113 of insulating member 110. Lower end 43b is located at a level below upper end 113a along the circumference. Since end 113 is provided outside of end 43a, end 113 is located between end 43a and lower casing 30.

Note that end 113 and end 43 a overlap each other by at least 1 mm in the Z-axis direction, for example, and may preferably overlap each other by at least 3 mm in the Z-axis direction or may more preferably overlap each other by at least 5 mm in the Z-axis direction. The numerical values 1 mm, 3 mm, and 5 mm indicate the lengths in the Z-axis direction.

Furthermore, spacing 74 is provided between end 113 and end 43a. Spacing 74 may be provided over the entire circumference or may be provided over a part of the circumference. Spacing 74 is narrow spacing in which high-temperature conductive gas generated by an electric arc during an interrupting operation can be cooled while passing. The width of spacing 74 (which is the distance between end 113 and end 43a; in the example in FIG. 2A, the length in the Y-axis direction) is less than or equal to 1 mm and, for example, is less than or equal to 0.5 mm. The width of spacing 74 is the average value of the distance between the end 113 and end 43a along the circumference, but may be the maximum value, the minimum value, the mode, the median, or the like of said distance.

Thus, when the high-temperature conductive gas flows in spacing 74, the conductive gas is cooled, meaning that the conductivity of the conductive gas can be reduced. The conductive gas flowing out of spacing 74 has reduced conductivity and thus, even when the conductive gas comes into contact with lower casing 30, the electric current is kept from flowing through conductor 50.

Note that spacing 74 does not need to be provided. In other words, end 113 and end 43a may be in contact over the entire circumference.

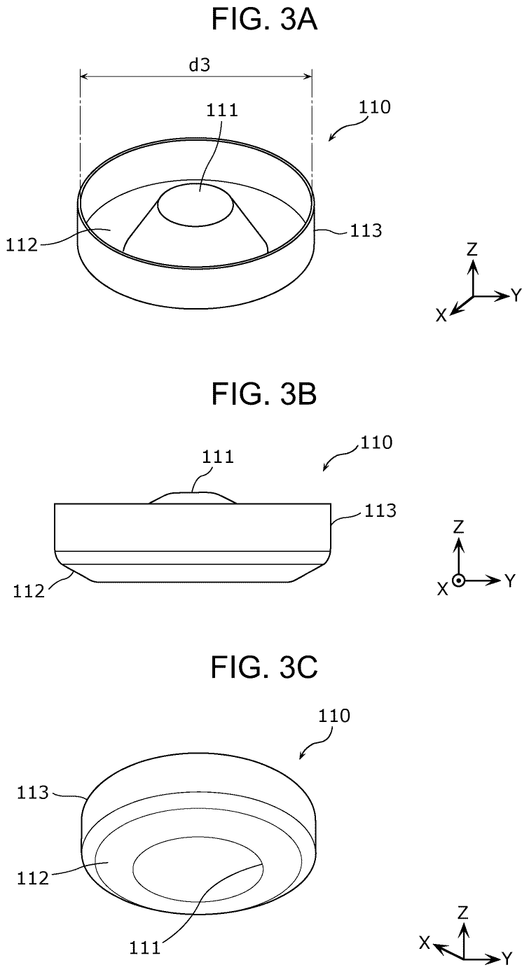

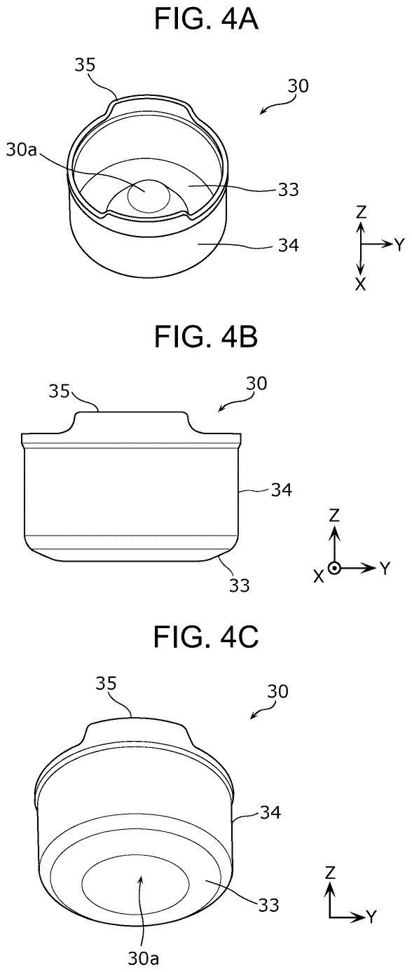

Next, the configurations of insulating member 110 and lower casing 30 will be described further with reference to FIG. 3A to FIG. 4C. FIG. 3A is a perspective view of insulating member 110 according to the present exemplary embodiment viewed from above. FIG. 3B is a front view of insulating member 110 according to the present exemplary embodiment. FIG. 3C is a perspective view of insulating member 110 according to the present exemplary embodiment viewed from below. FIG. 3A is a diagram of insulating member 110 illustrated in FIG. 3B that has been rotated about the Y-axis as a rotation axis to obtain a perspective view of insulating member 110 viewed from above, and FIG. 3C is a diagram of insulating member 110 illustrated in FIG. 3B that has been rotated about the Y-axis as a rotation axis to obtain a perspective view of insulating member 110 viewed from below.

As illustrated in FIG. 3A to FIG. 3C, first section 111 of insulating member 110 is a hollow member in the shape of a truncated cone with no bottom. Second section 112 includes: end 113; and a portion inclined so as to connect end 113 and first section 111. The inclined portion is tapered with an inner diameter increasing toward end 113. End 113 is a cylindrical member with no bottom that extends in the Z-axis direction.

FIG. 4A is a perspective view of lower casing 30 according to the present exemplary embodiment viewed from above. FIG. 4B is a front view of lower casing 30 according to the present exemplary embodiment. FIG. 4C is a perspective view of lower casing 30 according to the present exemplary embodiment viewed from below. FIG. 4A is a diagram of lower casing 30 illustrated in FIG. 4B that has been rotated about the Y-axis as a rotation axis to obtain a perspective view of lower casing 30 viewed from above, and FIG. 4C is a diagram of lower casing 30 illustrated in FIG. 4B that has been rotated about the Y-axis as a rotation axis to obtain a perspective view of lower casing 30 viewed from below.

As illustrated in FIG. 4A to FIG. 4C, projecting portion 30a of lower casing 30 is a hollow member in the shape of a truncated cone with no bottom. Bottom portion 33 is tapered with an inner diameter increasing toward side wall portion 34. Side wall portion 34 is a cylindrical member with no bottom that extends in the Z-axis direction. The length of side wall portion 34 in the Z-axis direction is greater than the length of end 113 in the Z-axis direction. The inner diameter of side wall portion 34 is greater than inner diameter d3 of end 113. Side wall portion 34 is configured to cover end 113 from the outside. Fixing portion 35, which is a portion for fixing upper casing 20 and lower casing 30, is provided protruding upward from side wall portion 34. Fixing portion 35 is joined by welding or the like to a fixing portion (not illustrated in the drawings) provided on upper casing 20 so as to protrude downward.

As described above, breaker device 1 is configured such that the inner surface of lower casing 30 is not exposed and resin-made members (resin member 40 and insulating member 110) having insulating properties partially overlap each other as viewed in the radial direction.

### Embodiment 2

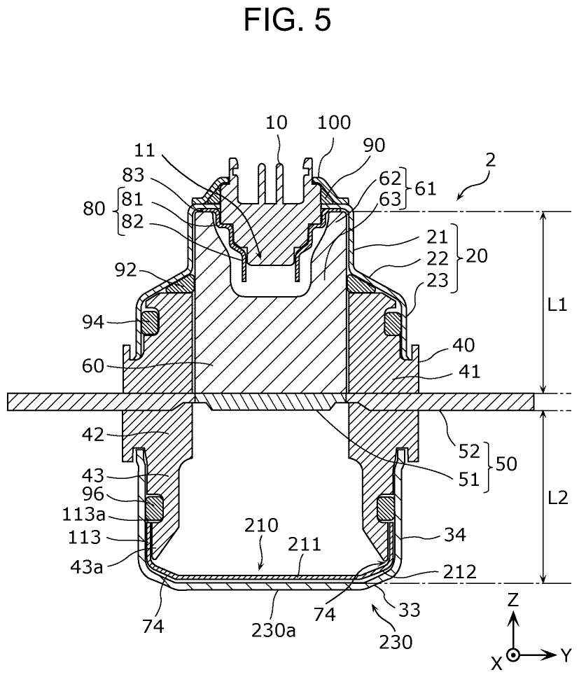

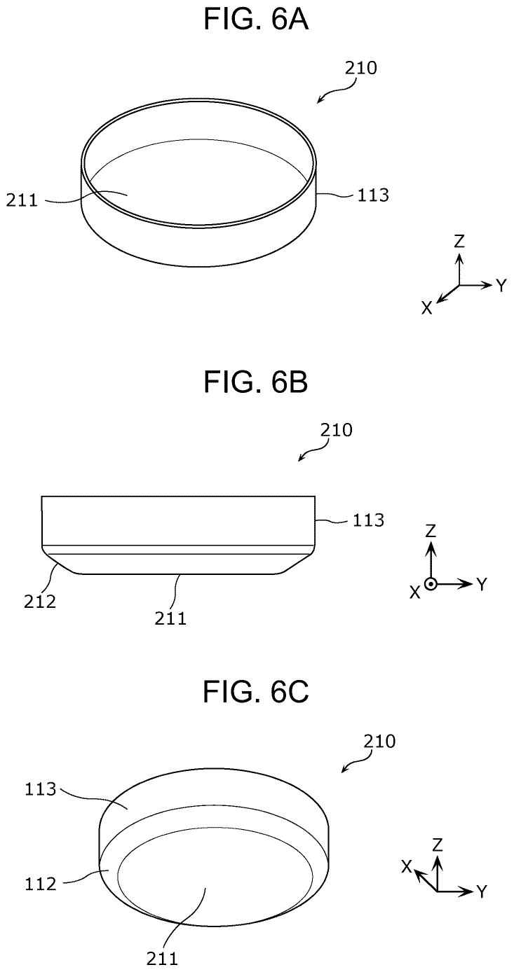

Hereinafter, the configuration of the breaker device according to the present exemplary embodiment will be described with reference to FIG. 5 to FIG. 6C. FIG. 5 is a cross-sectional view illustrating the configuration of breaker device 2 according to the present exemplary embodiment before an interrupting operation. FIG. 6A is a perspective view of insulating member 210 according to the present exemplary embodiment viewed from above. FIG. 6B is a front view of insulating member 210 according to the present exemplary embodiment. FIG. 6C is a perspective view of insulating member 210 according to the present exemplary embodiment viewed from below. FIG. 6A is a diagram of insulating member 210 illustrated in FIG. 6B that has been rotated about the Y-axis as a rotation axis to obtain a perspective view of insulating member 210 viewed from above, and FIG. 6C is a diagram of insulating member 210 illustrated in FIG. 6B that has been rotated about the Y-axis as a rotation axis to obtain a perspective view of insulating member 210 viewed from below.

Note that the following description will focus on differences from Embodiment 1, and description of details that are the same as or similar to those described in Embodiment 1 will be omitted or simplified. Breaker device 2 according to the present exemplary embodiment is different from breaker device 1 according to Embodiment 1 in that lower casing 230 has a flat bottom without projecting portion 30a.

As illustrated in FIG. 5, breaker device 2 includes lower casing 230 instead of lower casing 30 of breaker device 1 and includes insulating member 210 instead of insulating member 110.

Lower casing 230 includes plate-shaped portion 230a, bottom portion 33, and side wall portion 34. Plate-shaped portion 230a, bottom portion 33, and side wall portion 34 are integrally formed.

Plate-shaped portion 230a, which is a flat member, is disc-shaped in the present exemplary embodiment. The inner surface of plate-shaped portion 230a is flat.

As illustrated in FIG. 5 to FIG. 6C, insulating member 210 has a shape that follows the shape of lower casing 230. Insulating member 210 includes first section 121 and second section 112.

First section 211 is provided facing plate-shaped portion 230a and covers the inner surface of plate-shaped portion 230a. First section 211, which is a flat member, is disc-shaped in the present exemplary embodiment. In the present exemplary embodiment, first section 211 is provided at a predetermined distance from plate-shaped portion 230a without contact therewith before an interrupting operation.

Second section 212 is located at a level above first section 211 and covers the inner surface of bottom portion 33 and part of the inner surface of side wall portion 34. In the present exemplary embodiment, second section 112 is provided without contact with bottom portion 33 before an interrupting operation.

Thus, spacing 74 is provided between insulating member 210 and lower casing 230.

Note that the present exemplary embodiment has thus far described an example where end 113 of insulating member 210 is disposed between end 43a of resin member 40 and lower casing 230 in the radial direction, but the end of the resin member may be disposed between the end of the insulating member and the lower casing. A breaker device configured as just described will be described in the following variation.

### Variation of Embodiment 2

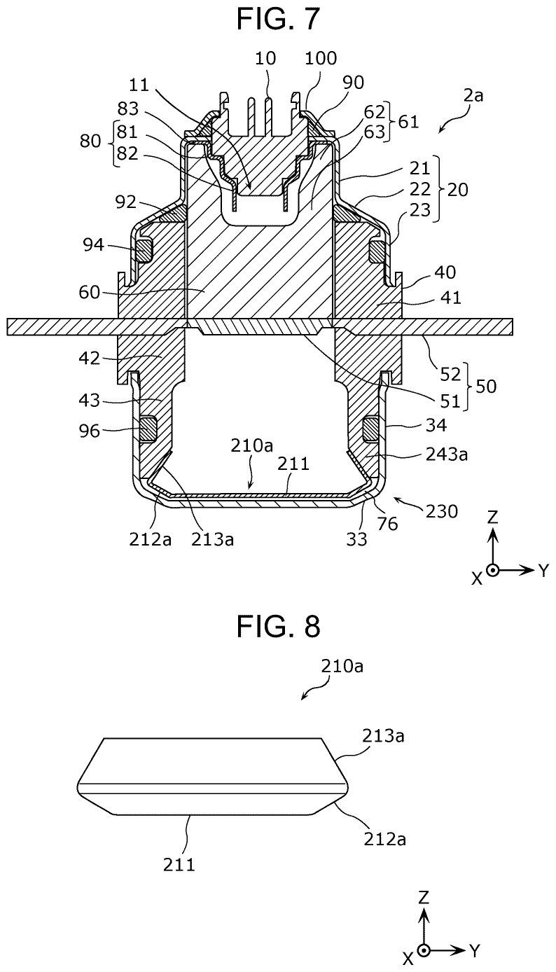

Hereinafter, the configuration of the breaker device according to the present variation will be described with reference to FIG. 7 and FIG. 8. FIG. 7 is a cross-sectional view illustrating the configuration of breaker device 2a according to the present variation before an interrupting operation. FIG. 8 is a front view of insulating member 210a according to the present variation.

As illustrated in FIG. 7, breaker device 2a includes: insulating member 210a instead of insulating member 210 of breaker device 2; and resin member 40 including end 243a instead of end 43a. As described above, breaker device 2a is configured so that end 243a of resin member 40 is located between end 213a of insulating member 210a and lower casing 230.

End 243a includes an inclined surface, the outside of which comes into contact with lower casing 230 and the inside of which is inclined.

As illustrated in FIG. 7 and FIG. 8, insulating member 210a has a shape that follows the shape of each of lower casing 230 and end 243a. Insulating member 210a includes first section 211 and second section 212a.

Second section 212a is located at a level about first section 211 and covers the inner surface of bottom portion 33 and the inner surface (inclined surface) of end 243a. In the present exemplary embodiment, second section 212a is provided so that second section 212a does not contact bottom portion 33 and end 213a contacts the inner surface of end 243a before an interrupting operation. End 213a has a shape that follows the shape of the inner surface of end 243a, and contacts the inner surface of end 243a over the entire circumference. End 213a is tapered with an inner diameter reduced upward.

As described above, breaker device 2a is configured such that the inner surface of lower casing 230 is not exposed and the resin-made members (resin member 40 and insulating member 210a) having insulating properties partially overlap each other in the radially outward direction in the order of insulating member 210a and resin member 40.

### Embodiment 3

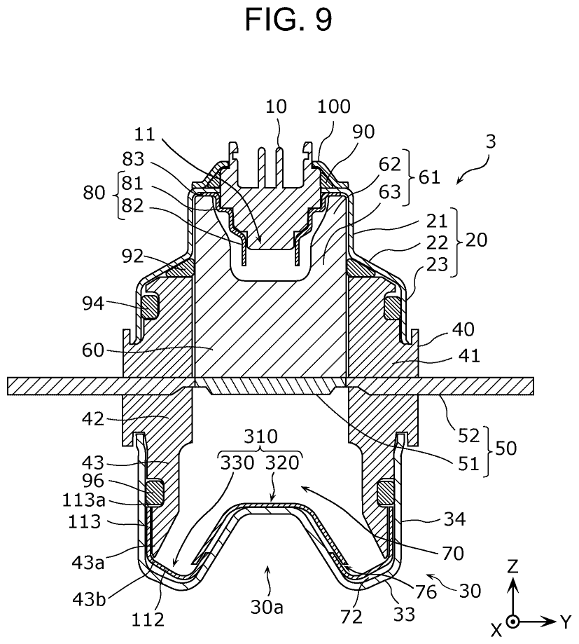

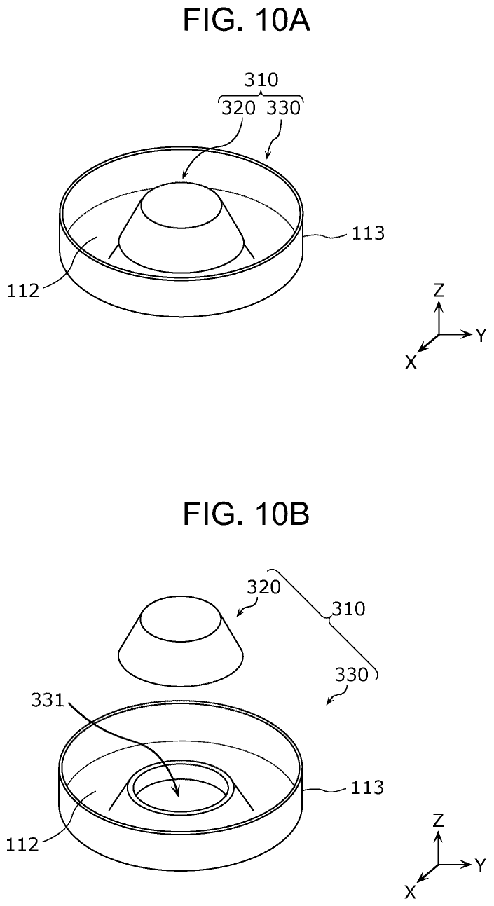

Hereinafter, the configuration of the breaker device according to the present exemplary embodiment will be described with reference to FIG. 9 to FIG. 10B. FIG. 9 is a cross-sectional view illustrating the configuration of breaker device 3 according to the present exemplary embodiment before an interrupting operation. FIG. 10A is a perspective view of insulating member 310 according to the present exemplary embodiment viewed from above. FIG. 10B is an exploded perspective view of insulating member 310 according to the present exemplary embodiment viewed from above.

Note that the following description will focus on differences from Embodiment 1, and description of details that are the same as or similar to those described in Embodiment 1 will be omitted or simplified. Breaker device 3 according to the present exemplary embodiment is different from breaker device 1 according to Embodiment 1 in that insulating member 310 is formed of a plurality of members.

As illustrated in FIG. 9, breaker device 3 includes insulating member 310 instead of insulating member 110 included in breaker device 1.

As illustrated in FIG. 9 to FIG. 10B, insulating member 310 includes first member 320 and second member 330. First member 320 and second member 330 are separate members. The term “separate members” herein means that first member 320 and second member 330 installed are physically separate. The term “separate members” may indicate that first member 320 and second member 330, which are separate members, are not fixed. Furthermore, the term “separate members” may indicate that first member 320 and second member 330 are separately manufactured in a manufacturing process.

First member 320 covers projecting portion 30a of lower casing 30. First member 320 covers the top of projecting portion 30a, for example. First member 320 has a shape that follows projecting portion 30a, and the cross-sectional shape of first member 320 is the shape of letter U rotated through 180 degrees. An end of first member 320 is a free end and can deform by the stress from pusher 60.

Second member 330 covers bottom portion 33 of lower casing 30. Second member 330 covers bottom portion 33 and partially covers side wall portion 34 and projecting portion 30a. Second member 330 has a shape that mainly follows bottom portion 33 and side wall portion 34, and the cross-sectional shape of second member 330 includes two U-shaped portions.

Second member 330 is disposed so as to overlap part of first member 320 as viewed in the radial direction. Thus, even when insulating member 310 is formed of first member 320 and second member 330, which are separate members, the inner surface of lower casing 230 can be kept from being exposed.

Second member 330 is not in contact with first member 320 in the overlapping area. In other words, spacing 76 is provided between first member 320 and second member 330. Similar to spacing 74, spacing 76 is narrow spacing in which high-temperature conductive gas generated by an electric arc during an interrupting operation can be cooled while passing. Furthermore, since second member 330 is not in contact with first member 320, the stress applied from pusher 60 to first member 320 can be kept from being transferred to second member 330. This means that second member 330 can be protected from being damaged by the stress from pusher 60.

Second member 330 includes end 113, and end 113 constitutes an end of insulating member 310.

As illustrated in FIG. 10A and FIG. 10B, first member 320 and second member 330 can be attached and detached. First member 320 is merely positioned over second member 330, for example. In other words, first member 320 is merely placed over second member 330 so as to cover opening 331 formed at the top of a portion of second member 330 that protrudes toward the internal space.

### Method for Manufacturing Breaker Device

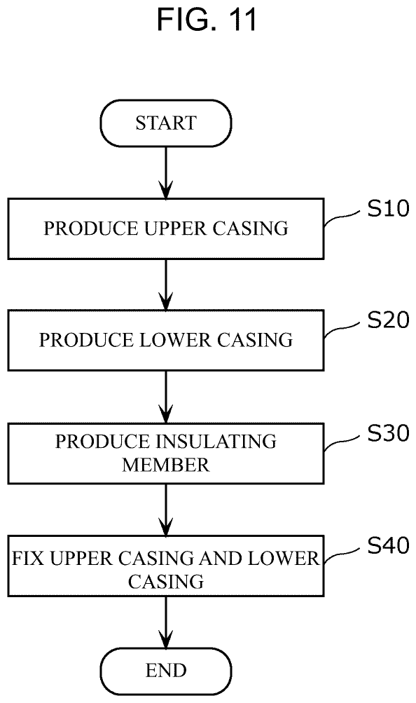

Next, the method for manufacturing the breaker device according to each of the exemplary embodiments or the like configured as described above will be described with reference to FIG. 11. FIG. 11 is a flowchart illustrating a manufacturing process of breaker device 1 according to Embodiment 1. In FIG. 11, the manufacturing process of breaker device 1 according to Embodiment 1 is illustrated, but the same applies to breaker devices 2, 2a, 3 according to the other exemplary embodiments and the variations.

As illustrated in FIG. 11, upper casing 20 is produced from resin or metal by resin or metal molding or the like (S10), lower casing 30 is produced from metal by metal molding or the like (S20), and insulating member 110 is produced from resin molding or the like (S30). Note that the order of Steps S10 to S30 can be changed and at least two of Steps S10 to S30 can be performed at the same time.

Next, upper casing 20 and lower casing 30 are fixed (S40). For example, upper casing 20 and lower casing 30 are joined together by welding or the like with igniter 10, resin member 40, conductor 50, pusher 60, protective portion 80, elastic members 90, 92, 94, 96 and insulating member 110 housed therein. At this time, upper casing 20 and lower casing 30 are seamlessly joined together with insulating member 110 housed therein so as to cover the inner surface of lower casing 30. As a result, breaker device 1 described above is produced

### Other Exemplary Embodiments

The breaker devices according to one or more aspects have been described thus far based on the exemplary embodiments, etc., but the present disclosure is not limited to these exemplary embodiments, etc. Various modifications to the present exemplary embodiments and forms configured by combining structural elements in different exemplary embodiments that can be conceived by those skilled in the art may be included within the present disclosure as long as these do not depart from the essence of the present disclosure.

The order of the steps in the method for manufacturing the breaker device described above may be changed. Furthermore, the steps in the method for manufacturing the breaker device described in the above exemplary embodiments may be performed in a single step or may be performed in separate steps. Note that the phrase “the steps are performed in a single step” is intended to include a situation in which the steps are performed using a single device, a situation in which the steps are sequentially performed, and a situation in which the steps are performed at the same location. The term “separate steps” is intended to include a situation in which the steps are performed using separate devices, a situation in which the steps are performed at different times (for example, on different dates), and a situation in which the steps are performed at different locations.

### Industrial Applicability

The present disclosure is useful in breaker devices that are disposed in an electrical circuit, etc.

### REFERENCE SIGNS LIST

1, 2, 2a, 3 breaker device
10 igniter
11 lid portion
11a opening portion
20 upper casing
21 small-diameter portion
22 connecting portion
23 large-diameter portion
30, 230 lower casing (cover member)
30a projecting portion
33 bottom portion
34 side wall portion
35 fixing portion
40 resin member
41 embedding portion
42, 81 first cylindrical portion
43, 82 second cylindrical portion
43a, 113, 213a, 243a end
43b lower end
50 conductor
51 separating portion
52 holding portion
60 pusher
61 recessed portion
62, 111, 211 first section
63, 112, 212, 212a second section
70 space
72 spacing (gap)
74, 76 spacing
80 protective portion
83 flange portion
90, 92, 94, 96 elastic member
100 fixing member
110, 210, 210a, 310 insulating member
113a upper end
230a plate-shaped portion
320 first member
330 second member
331 opening
d1, d2, d3 inner diameter

1. A breaker device comprising:
an igniter configured to generate gas;
a pusher located at a level below the igniter;
a conductor including a separating portion located below the pusher and a holding portion connected to the separating portion;
a cover member located at a level below the separating portion and made from metal;
an insulating member located inside the cover member and positioned at a level below the separating portion; and
a resin member located at least partially inside the cover member and configured to hold the holding portion, wherein
the pusher is configured to cut off the separating portion from the conductor by receiving pressure of the gas generated by the igniter,
the resin member and the insulating member cover an inner surface of the cover member,
an end of the insulating member and an end of the resin member overlap each other, and
a lower end of the end of the resin member is located at a level below an upper end of the end of the insulating member.

2. The breaker device according to claim 1, wherein
the end of the insulating member is located between the end of the resin member and the cover member.

3. The breaker device according to claim 1, wherein
the end of the resin member is located between the end of the insulating member and the cover member.

4. The breaker device according to claim 1, wherein
the cover member includes a projecting portion located below the insulating member, and
the projecting portion protrudes upward and is pressed by the pusher.

5. The breaker device according to claim 1, wherein
a gap is provided between the cover member and the insulating member, and
the gap is located below the insulating member.

6. The breaker device according to claim 4, wherein
a gap is provided between the cover member and the insulating member,
the insulating member includes:
a first section covering a top of the projecting portion of the cover member; and
a second section located at a level below the first section,
the second section covers an inner surface of a bottom portion of the cover member, and
the gap is located between the bottom portion of the cover member and a lower surface of the second section.

7. The breaker device according to claim 4, wherein
the insulating member includes:
a first member covering a top of the projecting portion of the cover member; and
a second member disposed to partially overlap the first member,
the second member covers an inner surface of a bottom portion of the cover member, and
the first member and the second member are separate members.

8. The breaker device according to claim 1, wherein
the resin member includes:
an embedding portion in which the holding portion is embedded;
a first cylindrical portion in which the pusher is disposed; and
a second cylindrical portion located at a level below the first cylindrical portion and having a diameter greater than a diameter of the first cylindrical portion, and
an inner diameter of the second cylindrical portion is less than an inner diameter of the insulating member.
